(19) United States
(12) Patent Application Publication
(10) Pub. No.: US 2003/0219608 A1
(43) Pub. Date: Nov. 27, 2003

(54) Metal transfer sheet, producing method thereof, and producing method of ceramic condenser

(76) Inventors: Hitoshi Ishizaka, Osaka (JP); Yasuhiko Yamamoto, Osaka (JP); Kazuo Ouchi, Osaka (JP); Takashi Oda, Osaka (JP); Takuji Okeyui, Osaka (JP)

Correspondence Address: Jean C. Edwards, SONNENSCHEIN NATH & ROSENTHAL, Wacker Drive Station, P.O. Box 061080, Chicago, IL, 60606-1080, US

(21) Appl. No.: 10/442,069

(22) Filed: May 21, 2003

(30) Foreign Application Priority Data
May 23, 2002 (JP) 2002-148469

(51) Int. Cl. B32B 15/04; C25D 5/50

(52) U.S. Cl. 428/469; 205/227; 205/271; 205/291; 428/671; 428/675

(57) ABSTRACT

A metal transfer sheet which is so low in peel-strength as to be transferred to an object to be transferred with ease and reliability; a producing method thereof; and a ceramic condenser producing method for producing a reliable, compact, thin-layer ceramic condenser with improved production efficiency by transferring a metal layer to the ceramic condenser by using the metal transfer sheet. After a first metal layer is formed on a carrier film in a sputtering or an electrolytic plating method, the member thus formed is dipped in plating solution and voltage is applied in such a way that the first metal layer side is anode, to form a passive film. Sequentially, with the polarity reversed, voltage is applied in such a way that the passive film side is cathode, to form the second metal layer. After this manner, a metal transfer sheet in which the first metal layer and the second metal layer are laminated through the passive film interposed therebetween is obtained. Thereafter, the second metal layer is transferred to a ceramic green sheet in the form of an internal electrode.

### BACKGROUND OF THE INVENTION

1. Field of the Invention

The present invention relates to a metal transfer sheet and a producing method thereof, and to a method of producing a ceramic condenser. More particularly, the present invention relates to a metal transfer sheet capable of transferring a metal layer to an object to be transferred and a producing method thereof, and to a method of producing a ceramic condenser having metal layers transferred thereto by using the metal transfer sheet.

2. Description of the Prior Art

A screen printing method is generally known as a method for forming electrodes of electronic components, such as internal electrodes of multilayer ceramic condenser. In recent years, proposals have been made to form a thin-layer electrode by using a pattern transfer technique, in order to realize high-capacity and miniaturization of electronic components.

For example, Japanese Patent No. 2990621 discloses a method for producing a multilayer ceramic electronic component by using the pattern transfer technique, which comprises the steps (a) of forming a first metal layer on a film by evaporation; (b) of forming a second metal layer on the first metal layer by wet plating; (c) of patterning the first and second metal layers; (d) of coating ceramic slurry on the film to cover the metal layers with the ceramic slurry, so as to form a ceramic green sheet; (e) of bringing the metal-layered green sheet carried on the film into press-contact with the ceramic green sheet or another metal-layered green sheet to laminate the metal-layered green sheet on the ceramic green sheet or another metal-layered green sheet; (f) of peeling the film; and (g) of baking the laminated ceramic green sheet.

The method described in Japanese Patent No. 2990621 cited above is intended to make use of weakness in adhesion (small peel-strength) of the first metal layer formed by evaporation to the film. However, this method cannot weaken the peel-strength sufficiently, so that it practically requires coating of a mold release agent on the film. Due to this, when the number of layers to be laminated is increased to meet the demand for realization of a high-capacity multilayer ceramic condenser, insufficient production is provided and also production reliability is lowered due to a remaining mold release agent.

### SUMMARY OF THE INVENTION

It is an object of the invention to provide a metal transfer sheet which is so low in peel-strength as to be transferred to an object with ease and reliability; a producing method thereof, and a producing method of a ceramic condenser for producing a reliable, compact, thin-layer ceramic condenser with improved production efficiency by transferring a metal layer to the ceramic condenser by using the metal transfer sheet.

The present invention provides a novel metal transfer sheet, wherein a first metal layer and a second metal layer are laminated through a passive film interposed therebetween.

In the metal transfer sheet of the present invention, the first metal layer may be formed of nickel and the second metal layer may be formed of nickel or copper. Also, the second metal layer may comprise a plurality of metal layers. In this case, the second metal layer may comprise a nickel layer and a copper layer.

It is preferable that the first metal layer is formed in a vapor deposition method or an electrolytic plating method; the second metal layer is formed in the electrolytic plating method; and the passive film is formed in such a way that voltage is applied in plating solution with its polarity reversed with respect to the electrolytic plating of the second metal layer.

Also, the present invention provides a novel metal transfer sheet producing method, comprising the steps of preparing a first metal layer; of forming a passive film by applying voltage in plating solution in such a way that the first metal layer side is anode; and of forming a second metal layer by applying voltage in the plating solution in such a way that the passive film side is cathode. In this method, it is preferable that the voltage is applied for 2-10 seconds in the step of forming the passive film.

Further, the present invention provides a novel method of producing a ceramic condenser using a metal transfer sheet having a first metal layer and a second metal layer which are laminated through a passive film interposed therebetween, the method comprising the steps of transferring the second metal layer of the metal transfer sheet to a ceramic green sheet; of laminating the ceramic green sheet to which the second metal layer was transferred; and of baking the ceramic green sheet laminated.

The metal transfer sheet producing method of the present invention can allow the form of the passive film forming an easy-releasable surface by controlling easy-controllable parameters of voltage applied and time for the voltage to be applied. This can allow precise and reliable control of the peel-strength, and as such can allow the production of the metal transfer sheet having improved stable transfer performances. In addition, since the metal transfer sheet producing method of the present invention can allow the form of the passive film by simply reversing the polarity with respect to the electrolytic plating of the second metal layer by use of the electrolytic plating device, the metal transfer sheet can be produced with ease and improved production efficiency.

The metal transfer sheet of the present invention can allow the second metal layer to be transferred to a transferred object easily and reliably by a small releasing force and also can allow the second metal layer to be formed in thin layer and transferred efficiently without using any mold release agent. Hence, the metal transfer sheet of the present invention can be properly used to form e.g. electrodes of electronic components and a circuit pattern of a circuit board including wiring and terminals. Particularly, the metal transfer sheet of the present invention can preferably be used to form an internal electrode of a multilayer ceramic condenser which has been demanded in recent years for further increase in capacity and reduction in size and thickness of layer.

According to the ceramic condenser producing method of the present invention, since the internal electrode can be formed on the ceramic green sheet in a thin circuit pattern with ease and reliability, increase in capacity and reduction in size and thickness of the ceramic condenser can be realized. Besides, since the ceramic condenser producing method of the present invention can allow the efficient transfer without using any mold release agent, the production efficiency and reliability of the ceramic condenser can be improved.

### BRIEF DESCRIPTION OF THE DRAWINGS

In the drawings:

FIG. 1 is the process drawing of an embodiment of a metal transfer sheet producing method of the present invention:

(a) illustrates the step of preparing a carrier film;

(b) illustrates the step of forming a first metal layer on the carrier film;

(c) illustrates the step of forming a passive film on the first metal layer; and

(d) illustrates the step of forming a second metal layer on the passive film,

FIG. 2 is the process drawing of a further embodiment of the metal transfer sheet producing method shown in FIG. 1, illustrating an alternative of the process of forming the second metal layer previously in the form of a specific circuit pattern,

(a) illustrates the step of preparing the carrier film;

(b) illustrates the step of forming a first metal thin layer by sputtering;

(c) illustrates the step of forming a first metal plated layer on the first metal thin layer by an electrolytic plating;

(d) illustrates the step of forming a plating resist on the first metal plated layer in an inverted pattern from a specific circuit pattern;

(e) illustrates the step of forming a passive film on a surface of the first metal plated layer on which the plating resist is not formed;

(f) illustrates the step of forming the second metal plated layer on a surface of the passive film by the electrolytic plating; and

(g) illustrates the step of removing the plating resist,

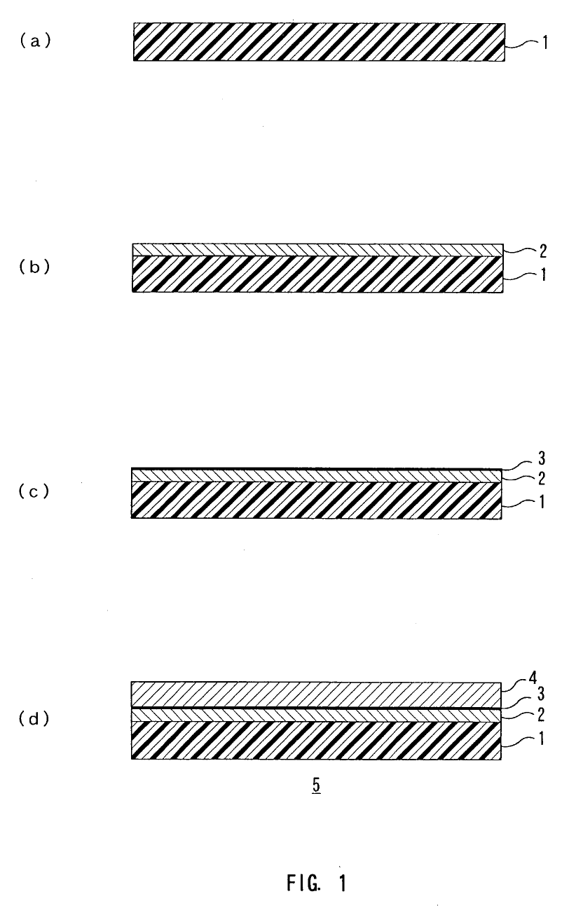

FIG. 3 is the process drawing of still further embodiment of the metal transfer sheet producing method shown in FIG. 1, illustrating further alternative of the process of forming the second metal layer previously in the form of a specific circuit pattern,

(a) illustrates the step of preparing the carrier film;

(b) illustrates the step of forming the first metal thin layer by sputtering;

(c) illustrates the step of forming the first metal plated layer on the first metal thin layer by the electrolytic plating;

(d) illustrates the step of forming the plating resist on the first metal plated layer in an inverted pattern from a specific circuit pattern;

(e) illustrates the step of forming the passive film on a surface of the first metal plated layer on which the plating resist is not formed;

(f) illustrates the step of forming the second metal plated layer on a surface of the passive film by the electrolytic plating;

(g) illustrates the step of forming the third metal plated layer on the second metal plated layer by the electrolytic plating; and

(h) illustrates the step of removing the plating resist,

FIG. 4 is the process drawing of another embodiment of the metal transfer sheet producing method shown in FIG. 1, illustrating still further alternative of the process of forming the second metal layer previously in the form of a specific circuit pattern,

(a) illustrates the step of preparing the carrier film;

(b) illustrates the step of forming the first metal thin layer by sputtering;

(c) illustrates the step of forming the plating resist on the first metal thin layer in an inverted pattern from a specific circuit pattern;

(d) illustrates the step of forming the passive film on a surface of the first metal thin layer on which the plating resist is not formed;

(e) illustrates the step of forming the second metal plated layer on a surface of the passive film by the electrolytic plating; and

(f) illustrates the step of removing the plating resist,

FIG. 5 is the process drawing of still another embodiment of the metal transfer sheet producing method shown in FIG. 1, illustrating another alternative of the process of forming the second metal layer previously in the form of a specific circuit pattern,

(a) illustrates the step of preparing the carrier film;

(b) illustrates the step of forming the first metal thin layer by sputtering;

(c) illustrates the step of forming the first metal plated layer on the first metal thin layer by the electrolytic plating;

(d) illustrates the step of forming the passive film on a surface of the first metal plated layer;

(e) illustrates the step of forming the second metal plated layer on a surface of the passive film by the electrolytic plating;

(f) illustrates the step of forming an etching resist on the second metal plated layer in a pattern identical to a specific circuit pattern;

(g) illustrates the step of etching the second metal plated layer, the passive film and first metal plated layer, with the etching resist as a resist; and

(h) illustrates the step of removing the etching resist,

FIG. 6 is the process drawing of a method for producing a multilayer ceramic condenser by using the metal transfer sheet:

(a) illustrates the step of putting the second metal layer of the metal transfer sheet into contact with a ceramic green sheet and putting pressure thereon;

(b) illustrates the step of transferring the metal transfer sheet to the ceramic green sheet; and

(c) illustrates the step of producing a multilayer ceramic condenser by layering ceramic green sheets, each having the second metal layer transferred thereto, and baking the multilayered ceramic green sheet,

FIG. 7 is the process drawing of another method for producing a multilayer ceramic condenser by using the metal transfer sheet:

(a) illustrates the step of putting the second metal layer of the metal transfer sheet into contact with an adhesive of an adhesive tape;

(b) illustrates the step of primarily transferring the second metal layer of the metal transfer sheet onto the adhesive of the adhesive tape;

(c) illustrates the step of coating the adhesive on the ceramic green sheet; and

(d) illustrates the step of putting the second metal layer transferred to the adhesive tape into contact with the adhesive of the ceramic green sheet, and

FIG. 8 is the process drawing of yet another method for producing a multilayer ceramic condenser by using the metal transfer sheet, following to the process of FIG. 7:

(e) illustrates the step of secondarily transferring the second metal layer transferred to the adhesive tape onto the adhesive of the ceramic green sheet; and

(f) illustrates the step of producing a multilayer ceramic condenser by layering the ceramic green sheets, each having the second metal layer transferred thereto, and baking the multilayered ceramic green sheet.

### DETAILED DESCRIPTION OF THE PREFERRED EMBODIMENTS

Referring to FIG. 1 illustrating the production drawing of an embodiment of a metal transfer sheet producing method of the present invention, a producing method of one preferred embodiment of the metal transfer sheet of the present invention will be described below.

In this method, a carrier film 1 is prepared, first, as shown in FIG. 1(a). Known carrier films may be used as the carrier film 1, without any particular limitation. For example, known plastic films, such as polyethylene film, polypropylene film, polystyrene film, polyvinylchloride film, polyester film, polycarbonate film, polyimide film, polysulfone film, polyethersulfone film, polyamide film, polyamide-imide film, polyether ketone film, and polyphenylene sulfide film, can be used as the carrier film 1. Of these known films, a polyimide film is preferable in terms of dimensional stability and heat resistance, while on the other hand, a polyester film, such as a polyethylene terephthalate film, is preferably used in terms of material cost. The thickness of the carrier film 1 is usually in the range of 20-40 μm, though no particular limitation is imposed thereon.

A surface of the carrier film 1 on which the first metal layer 2 is formed may be surface-treated by a known surface treatment, such as an alkali treatment and a plasma treatment.

Then, a first metal layer 2 is formed on the carrier film 1, as shown in FIG. 1(b). The first metal layer 2 is formed in a known method without any particular limitation. The methods that may be used to form the first metal layer 2 include, for example, vapor depositions, such as a vacuum deposition, an ion plating process and a sputtering, and plating methods, such as an electrolytic plating and an electroless plating.

Among the methods cited above, the vapor depositions, particularly the sputtering, is preferable in that the method can provide good surface smoothness and can also provide good smoothness of the second metal layer 4 in a post-process.

Known metals may be used to form the first metal layer 2, without any particular limitation. For example, Fe, Ni, Cr, Co, Pb, Sn, Zn, Cu, Pd, Au and Ag and alloys thereof can be cited. When the first metal layer 2 is formed by the electrolytic plating and the like, followed by the forming of a passive film 3, Fe, Ni, Cr, Co, Pb, Sn, Zn and Cu, which are the metals that may form the passive film 3, particularly Ni and Cu, are preferably used among the metals cited above.

The first metal layer 2 may be in the form of a thin metal layer only formed by the vapor deposition, for example. Alternatively, the first metal layer 2 may be in the form of combination of the thin metal layer formed, for example, by the vapor deposition and an electrolytic plated layer formed on the thin metal layer by the electrolytic plating. Further, the first metal layer 2 may be in the form of combination of the thin metal layer formed, for example, by the electroless plating and the electrolytic plated layer formed on the thin metal layer by the electrolytic plating. The number of layers and the methods used for forming those layers may be selectively combined.

For example, when the first metal layer 2 is in the form of the thin metal layer, the thickness of the first metal layer 2 is in the approximate range of 300-5,000 Å, while on the other hand, when the first metal layer 2 is in the form of the electrolytic plated layer, the thickness of the first metal layer 2 is in the approximate range of 0.1-1.0 μm, though no particular limitation is imposed thereon. In the first metal layer 2 having a thickness less than 300 Å, the electric resistance increases so that sufficient plating current cannot be supplied.

Then, in this method, the passive film 3 is formed on the surface of the first metal layer 2, as shown in FIG. 1(c). The passive film 3 is formed in a known passivation without any particular limitation. The methods that may be used to form the passive film 3 include, for example, electrochemical passivation and chemical passivation. Preferably, the passive film 3 is formed by polarizing an anode or a cathode and controlling the electric potential in passivity or in transpassivity by the electrochemical passivation. The metals that may be used to form the passive film 3 include, for example, Fe, Ni, Cr, Co, Pb, Sn, Zn and Cu. Ni and Cu are preferably used. The use of Ni and Cu can allow further reduction in peel-strength of the metal transfer sheet 5.

To be more specific, for example when a second metal layer 4 as mentioned later is formed by the electrolytic plating, the carrier film 1 having the first metal layer 2 laminated thereon is dipped in plating solution and then voltage is applied with its polarity reversed (usually in such a way that the first metal layer 2 side is anode), in contrast with when the second metal layer 4 is plated by the electrolytic plating.

This method can allow the form of the passive film 3 by controlling easy-controllable parameters of voltage applied and time for the voltage to be applied. This can allow precise and reliable control of the peel-strength, and as such can allow the production of the metal transfer sheet 5 having improved stable transfer performances. In addition, since the use of the electrolytic plating device can allow the form of the passive film 3 by simply reversing the polarity with respect to the second metal layer 4 as electrolytic plated, the metal transfer sheet 5 can be produced with ease and improved production efficiency.

For example, when the passive film 3 is formed from nickel and equivalent, the carrier film 1 having the first metal layer 2 laminated thereon is dipped in nickel plating solution and then voltage of +0.2-+5V, preferably +0.4-+2V, is applied for 0.1-60 sec., preferably 2-10 sec., in such a way that the first metal layer 2 side is anode. When the time for the voltage to be applied is shorter than 0.1 seconds, there is a tendency that it is hard to form the passive film 3 on the first metal layer 2. On the other hand, when the time for the voltage to be applied is longer than 60 seconds, there is the possibility that the first metal layer 2 may be damaged.

In this application of voltage, it is preferable to control the electric potential in an electrochemical measuring method such as potentiostat, for example, in which a reference electrode is set in plating solution and an electric current is flown, while measuring an electric potential of the working electrode (first metal layer 2) against the reference electrode.

The above-noted conditions required for forming the passive film 3 (voltage applied and time for the voltage to be applied) are applicable to other metals as well as to nickel. Also, since an absolute value of the electric current required for the forming of the passive film 3 is usually very small, as compared with an absolute value of the electric current required for the electrolytic plating, the voltage applied to the other metals can be determined with reference to the conditions for the common electrolytic plating by using the voltage reserved in polarity as a guide.

As a result of this, the passive film 3 having a thickness of some tens of A can be formed on the first metal layer 2. Since the passive film 3 thus formed is a conductor or a semiconductor, the second metal layer 4 can be formed thereon by the electrolytic plating.

Then, in this method, the second metal layer 4 is formed on the surface of the passive film 3 to obtain the metal transfer sheet 5, as shown in FIG. 1(d). The second metal layer 4 is formed in a known method without any particular limitation. The methods that may be used to form the second metal layer 4 include, for example, the vapor depositions, such as the vacuum deposition, the ion plating process and the sputtering, and the plating methods, such as the electrolytic plating and the electroless plating, as is the case with the forming of the first metal layer 2.

A known metal may be used as a metal used for forming the second metal layer 4 without any particular limitation. For example, Fe, Ni, Cr, Co, Pb, Sn, Zn, Cu, Pd, Ir, Au, Ag, Pt, Rh and alloys thereof can be cited. When the passive film 3 is formed, followed by the forming of the second metal layer 4, Fe, Ni, Cr, Co, Pb, Sn, Zn and Cu, which are the metals used for forming the passive film 3, can also be used for forming the second metal layer 4 without change. Among others, Ni and Cu are preferably used. The use of Ni and Cu can allow further reduction in peel-strength of the metal transfer sheet 5.

The second metal layer 4 may be in the form of a plurality of electrolytic plated layers formed by the electrolytic plating, for example. The number of layers and the methods used for forming those layers may be selectively combined. Though no particular limitation is imposed on thickness of the second metal layer 4, the thickness of the second metal layer 4 is in the approximate range of 0.1-3 μm, for example.

To be more specific, for example when the second metal layer 4 is formed by the electrolytic plating, the passive film 3 is formed on the surface of the first metal layer 2 in the plating solution and then voltage is applied with its polarity reversed (usually in such a way that the passive film 3 side is cathode).

For example, when the second metal layer 4 is formed from nickel and equivalent, the passive film 3 is formed on the surface of the first metal layer 2 in the nickel plating solution, first. Then, after the polarity of voltage is reversed in such a way that the passive film 3 side is cathode, the voltage is applied for example for 1-180 sec., preferably 5-60 sec., in such a manner that the current density can be for example in the range of −0.5-−40 A/dm², preferably −2.0-15 A/dm².

The forming of the second metal layer 4 may be separated from the forming of the passive film 3 (industrially, in separate production lines from each other).

In the metal transfer sheet 5 thus obtained, the first metal layer 2 and the second metal layer 4 are laminated to each other through the passive film 3. With the passive film 3 being as an easy-releasable surface, the metal transfer sheet 5 thus constructed can allow the second metal layer 4 to be transferred to a transferred object easily and reliably by a small releasing force by adhesive bonding the metal transfer sheet 5 to the transferred object and then peeling it therefrom.

The carrier film 1 is not indispensable. The metal transfer sheet 5 may be used without using the carrier film 1.

This metal transfer sheet 5 can allow the efficient transfer of the second metal layer 4 without using any mold release agent. Hence, this metal transfer sheet 5 can be properly used to form e.g. electrodes of electronic components and a circuit pattern of a circuit board including wiring and terminals, not exclusively used to form them.

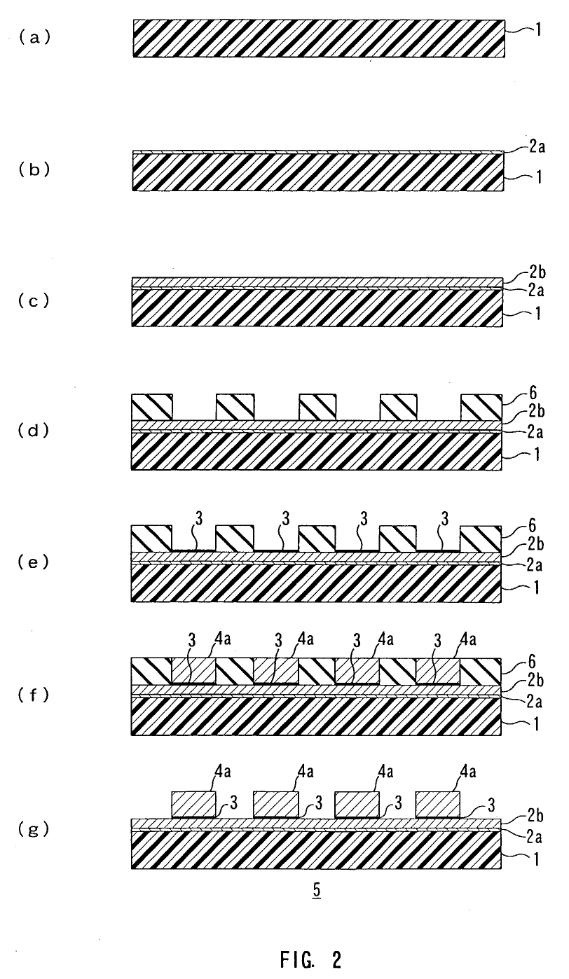

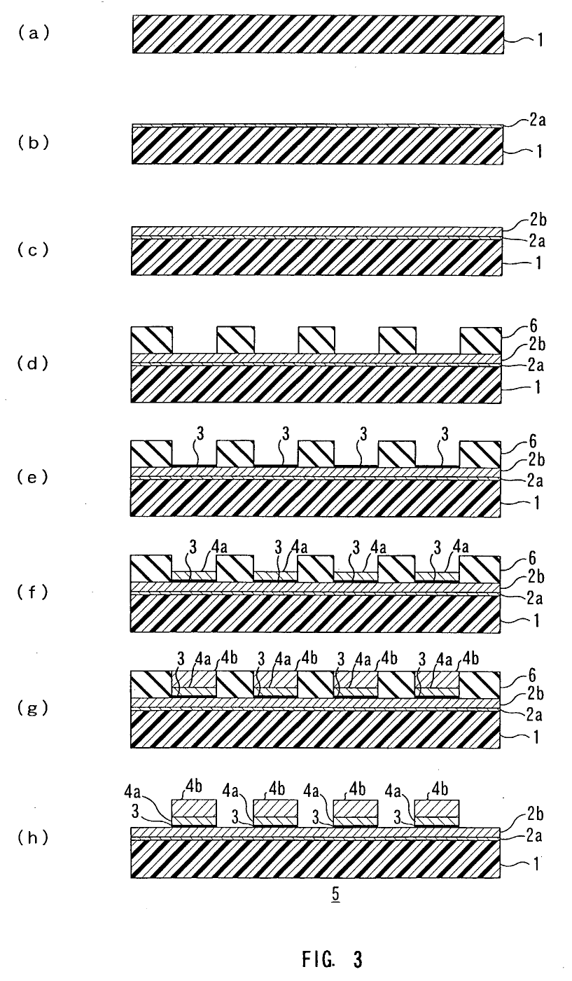

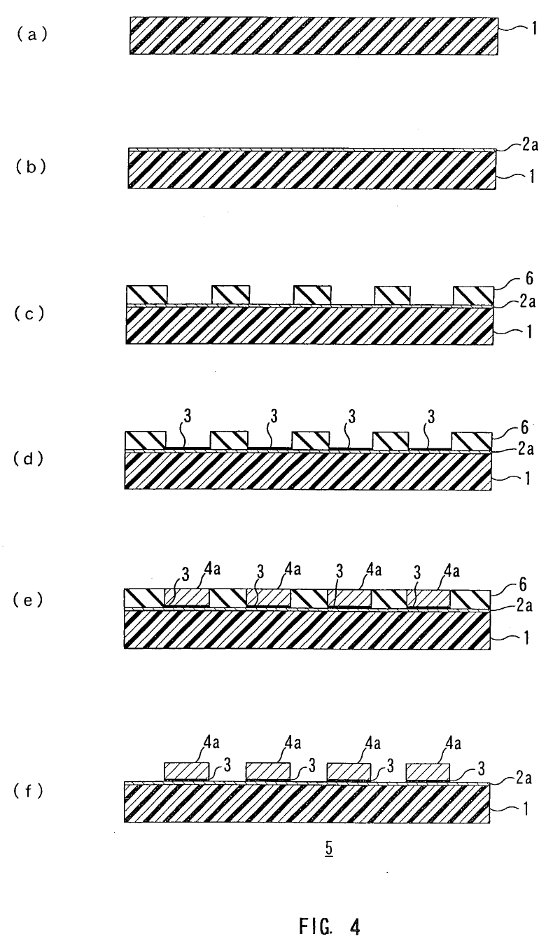

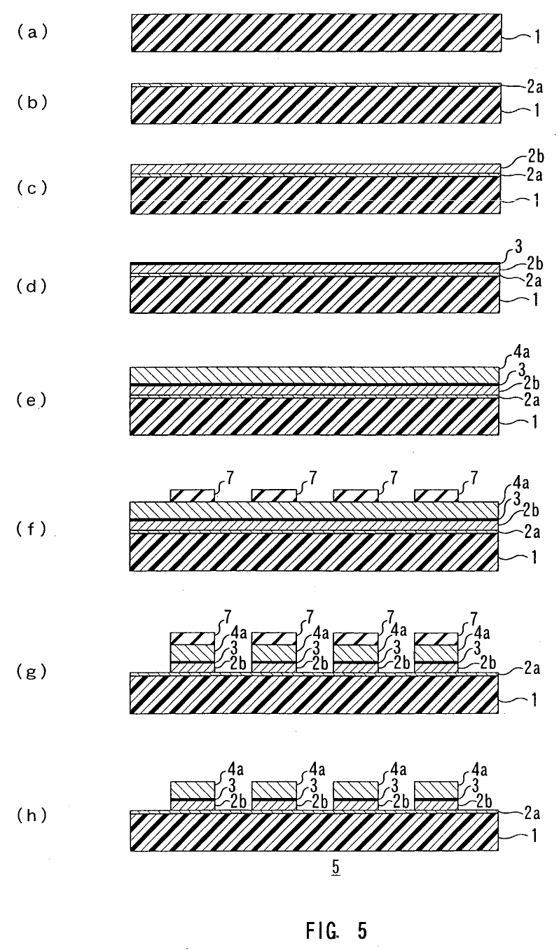

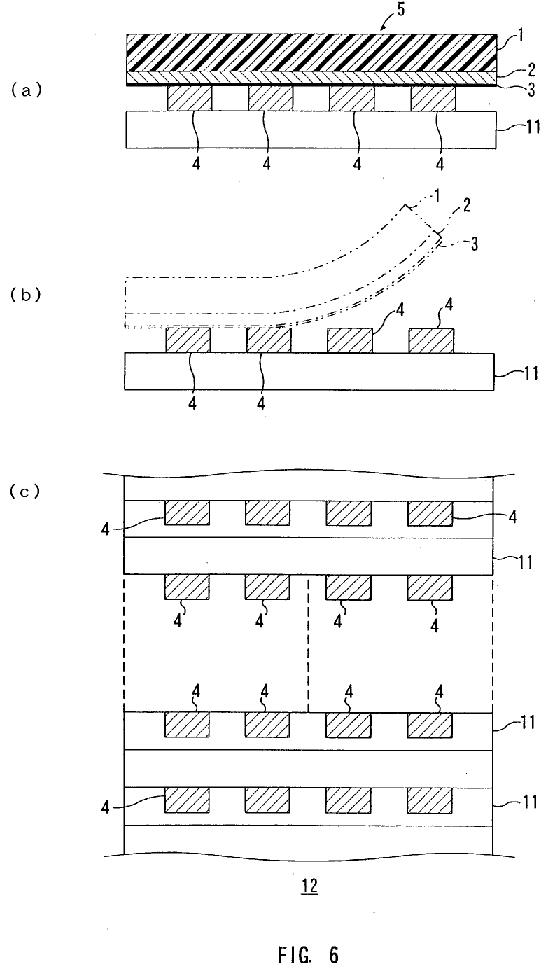

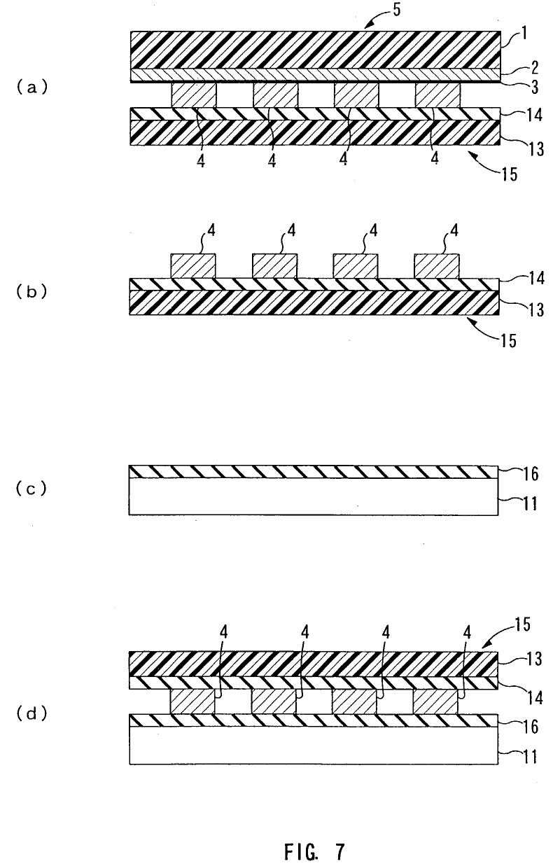

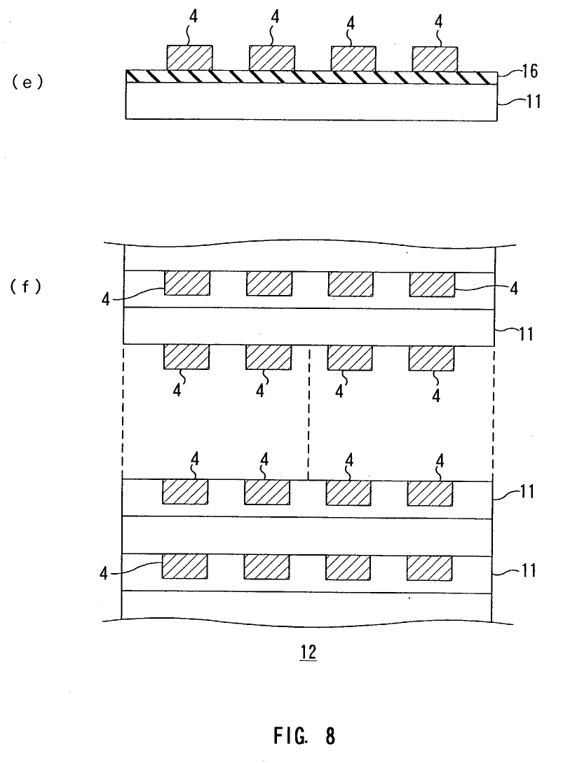

Referring now to FIGS. 2-5, the process of forming the second metal layer 4 in the form of a specific circuit pattern in this metal transfer sheet 5 will be described further concretely.

In the method shown in FIG. 2, the carrier film 1 is prepared in the same manner as in the embodiment mentioned above, first, as shown in FIG. 2(a). Thereafter, a first metal thin film 2a is formed as the first metal layer 2 by the sputtering, as shown in FIG. 2(b). The first metal thin film 2a is preferably formed of nickel or copper and has thickness of 300-3,000 Å, for example. Then, a first metal plated layer 2b serving as the first metal layer 2 is formed on the first metal thin film 2a by the electrolytic plating, as shown in FIG. 2(c). The first metal plated layer 2b is preferably formed of nickel and copper. The first metal plated layer 2b can be formed by applying voltage in such a way that the first metal thin film 2a is cathode. It is preferable that the first metal plated layer 2b has a thickness of 0.1-0.5 μm. Thereafter, a plating resist 6 is formed on the first metal plated layer 2b in an inverted pattern from a specific circuit pattern, as shown in FIG. 2(d). The plating resist 6 may be formed in a specific resist pattern in a known method using e.g. a dry film photoresist or equivalent.

Then, the passive film 3 is formed on a surface of the first metal plated layer 2b where no plating resist 6 is formed, as shown in FIG. 2(e). Sequentially, a second metal plated layer 4a serving as the second metal layer 4 is formed on a surface of the passive film 3 by the electrolytic plating, as shown in FIG. 2(f).

The passive film 3 can be formed in such a manner that the carrier film 1 having the first metal plated layer 2b and first metal thin film 2a laminated thereon is dipped in plating solution of a second metal plated layer 4a to be sequentially formed and then voltage is applied in such a way that the first metal plated layer 2b side is anode.

The second metal plated layer 4a can be formed in such a manner that after the forming of the passive film 3, voltage is applied with its polarity reversed in the plating solution in such a way that the passive film 3 side is cathode.

Nickel, copper and the like are preferably used for the passive film 3 and the second metal plated layer 4a. The thickness of the second metal plated layer 4a is preferably in the range of 0.1-3 μm, for example.

This method can allow the passive film 3 and the second metal plated layer 4a to be formed continuously by simply reversing the polarity and by using simple equipment. The forming of the passive film 3 and the forming of the second metal plated layer 4a may be performed in separate production lines.

Then, the plating resist 6 is removed to obtain the metal transfer sheet 5 having the second metal plated layer 4a formed in a specific circuit pattern, as shown in FIG. 2(g). The plating resist 6 can be removed by a known etching such as chemical etching (wet-etching) or by peeling, without any particular limitation.

The second metal layer 4 may be in the form of a double layer comprising the second metal plated layer 4a and a third metal plated layer 4b, as shown in FIG. 3(h). In the method shown in FIG. 3, the same processes as those shown in FIG. 2 are taken (the processes of FIG. 3(a)-(e) correspond to the processes of FIG. 2(a)-(e) and like numerals refer to like parts) until the second metal plated layer 4a is formed, as shown in FIG. 3(f), and, thereafter, the third metal plated layer 4b serving as the second metal layer 4 is formed on the second metal plated layer 4a by the electrolytic plating, as shown in FIG. 3(g). The third metal plated layer 4b can be formed by applying voltage in the plating solution in such a way that the second metal layer 4 side is cathode in the same manner as in the above.

When the second metal layer 4 is formed in the form of a double layer, like this, the third metal plated layer 4b which is not laminated directly on the passive film 3 may be formed of any proper metal selected from a variety of metals in accordance with its intended purpose and application, independent of the metals of which the passive film 3 is formed.

To be more specific, the second metal plated layer 4a and the third metal plated layer 4b are preferably formed of nickel and copper, respectively. Preferably, the second metal plated layer 4a has a thickness of 0.1-0.5 μm, for example, and the third metal plated layer 4b has a thickness of 0.1-10 μm, for example.

In the method shown in FIG. 4, the carrier film 1 is prepared in the same manner as in the embodiment mentioned above, first, as shown in FIG. 4(a). Thereafter, the first metal thin film 2a is formed as the first metal layer 2 by the sputtering, as shown in FIG. 4(b). The first metal thin film 2a is preferably formed of nickel or copper and has thickness of 300-3,000 Å, for example. Then, the plating resist 6 is formed on the first metal thin film 2a in an inverted pattern from a specific circuit pattern, as shown in FIG. 4(c). The plating resist 6 may be formed in a specific resist pattern in a known method using e.g. a dry film photoresist or equivalent.

Then, the passive film 3 is formed on a surface of the first metal thin film 2a where no plating resist 6 is formed, as shown in FIG. 4(d). Sequentially, the second metal plated layer 4a serving as the second metal layer 4 is formed on a surface of the passive film 3 by the electrolytic plating, as shown in FIG. 4(e).

The passive film 3 can be formed in such a manner that the carrier film 1 having the first metal thin film 2a laminated thereon is dipped in plating solution of the second metal plated layer 4a to be sequentially formed and then voltage is applied in such a way that the first metal thin film 2a side is anode.

The second metal plated layer 4a can be formed in such a manner that after the forming of the passive film 3, voltage is applied with its polarity reversed in the plating solution in such a way that the passive film 3 side is cathode.

Nickel, copper and the like are preferably used for the passive film 3 and the second metal plated layer 4a. The thickness of the second metal plated layer 4a is preferably in the range of 0.1-3 μm, for example.

This method can allow the passive film 3 and the second metal plated layer 4a to be formed continuously by simply reversing the polarity. The forming of the passive film 3 and the forming of the second metal plated layer 4a may be performed in separate production lines.

Then, the plating resist 6 is removed to obtain the metal transfer sheet 5 having the second metal plated layer 4a formed in a specific circuit pattern, as shown in FIG. 4(f). The plating resist 6 can be removed by a known etching such as chemical etching (wet-etching) or by peeling, without any particular limitation.

In the method shown in FIG. 5, the carrier film 1 is prepared in the same manner as in the embodiment mentioned above, first, as shown in FIG. 5(a). Thereafter, the first metal thin film 2a is formed as the first metal layer 2 by the sputtering, as shown in FIG. 5(b). The first metal thin film 2a is preferably formed of nickel or copper and has thickness of 300-3,000 Å, for example. Then, the first metal plated layer 2b serving as the first metal layer 2 is formed on the first metal thin film 2a by the electrolytic plating, as shown in FIG. 5(c). The first metal plated layer 2b is preferably formed of nickel or copper. The first metal plated layer 2b can be formed by applying voltage in such a way that the first metal thin film 2a side is cathode, as mentioned above. Preferably, the first metal plated layer 2b has thickness of 0.1-0.5 μm, for example.

Thereafter, the passive film 3 is formed on the surface of the first metal plated layer 2b, as shown in FIG. 5(d). Sequentially, the second metal plated layer 4a serving as the second metal layer 4 is formed on the surface of the passive film 3 by the electrolytic plating, as shown in FIG. 5(e).

The passive film 3 can be formed in such a manner that the carrier film 1 having the first metal plated layer 2b and the first metal thin film 2a laminated thereon is dipped in plating solution of the second metal plated layer 4a to be sequentially formed and then voltage is applied in such a way that the first metal plated later 2b side is anode.

The second metal plated layer 4a can be formed in such a manner that after the forming of the passive film 3, voltage is applied with its polarity reversed in the plating solution in such a way that the passive film 3 side is cathode.

Nickel, copper and the like are preferably used for the passive film 3 and the second metal plated layer 4a. The thickness of the second metal plated layer 4a is preferably in the range of 0.1-3 μm, for example.

This method can allow the passive film 3 and the second metal plated layer 4a to be formed continuously by simply reversing the polarity. The forming of the passive film 3 and the forming of the second metal plated layer 4a may be performed in separate production lines.

Then, an etching resist 7 is formed on the second metal plated layer 4a in the same pattern as that of the specific circuit pattern, as shown in FIG. 5(f). The etching resist 7 may be formed in a specific resist pattern by a known method by using the dry film photoresist, for example.

Thereafter, the second metal plated layer 4a, the passive film 3 and the first metal plated layer 2b are etched with this etching resist 7 as the resist, as shown in FIG. 5(g). The second metal plated layer 4a, the passive film 3 and the first metal plated layer 2b may be etched in the chemical etching (wet-etching) using a known etching solution.

Then, the etching resist 7 is removed to obtain the metal transfer sheet 5 having the second metal plated layer 4a formed in a specific circuit pattern, as shown in FIG. 5(h). The etching resist 7 can be removed by a known etching such as the chemical etching (wet-etching) or by peeling, though no particular limitation is imposed on the removing method.

The metal transfer sheet 5 having the second metal layer 4 formed in a specific circuit pattern thus produced can allow the efficient and effective forming of the internal electrodes of the multilayer ceramic condenser by a transferring technology.

Referring now to FIG. 6, a method for producing a multilayer ceramic condenser by using the metal transfer sheet 5 will be described below.

In this producing method, the second metal layer 4 of the metal transfer sheet 5 is put into contact with a ceramic green sheet 11, first, as shown in FIG. 6(a), and, then, the metal transfer sheet 5 is pressed from the carrier film 1 side toward the ceramic green sheet 11. Thereafter, when the metal transfer sheet 5 is peeled, the second metal layer 4 is released from the first metal layer 2 via the passive film 3 which serves as the easy-releasable surface. As a result of this, the second metal layer 4 is transferred onto the ceramic green sheet 11 in the form of the internal electrode of the specific circuit pattern, as shown in FIG. 6(b).

Sequentially, after a required number of ceramic green sheets 11, each having the second metal layer 4 transferred thereto in the form of the specific circuit pattern, are layered, the ceramic green sheets 11 are baked, for example, at a temperature in the approximate range of 400° C.-1,200° C. to thereby produce a multilayer ceramic condenser 12, as shown in FIG. 6(c).

As a result of the multilayer ceramic condenser 12 being produced in this manner, the second metal layer 4 corresponding to the circuit pattern is transferred onto the ceramic green sheet 11 and thus the internal electrode is formed on the ceramic green sheet 11 in a thin circuit pattern with ease and reliability. This can allow realization of high-capacity and miniaturization in size and thickness of the multilayer ceramic condenser 12. Besides, since this metal transfer sheet 5 can allow the efficient transfer without using any mold release agent, the production efficiency and reliability of the multilayer ceramic condenser 12 can be improved.

For example, the following can be cited as an alternative method for producing the multilayer ceramic condenser 12 by using the metal transfer sheet 5. The second metal layer 4 of the metal transfer sheet 5 is primarily transferred to an adhesive tape, first; then, the second metal layer 4 is secondarily transferred from the adhesive tape to the ceramic green sheet 11; and a required number of ceramic green sheets 11, each having the second metal layer 4 transferred thereto, are layered and then baked.

To be more specific, in this alternative method, an adhesive tape 15 comprising a base material 13 coated with adhesive 14 is prepared, first, as shown in FIG. 7(a). The second metal layer 4 of the metal transfer film 5 is put into contact with the adhesive 14 of the adhesive tape 15 and pressed in the same manner as in the above, whereby the second metal layer 4 is primarily transferred to the adhesive tape 15, as shown in FIG. 7(b). Also, an adhesive 16 is coated on the ceramic green sheet 11, as shown in FIG. 7(c). Then, the second metal layer 4 transferred to the adhesive tape 15 is put into contact with the adhesive 16 of the ceramic green sheet 11, as shown in FIG. 7(d), and then pressed in the same manner as in the above, whereby the second metal layer 4 is secondarily transferred to the ceramic green sheet 11, as shown in FIG. 8(e). Thereafter, a required number of ceramic green sheets 11, each having the second metal layer 4 transferred thereto, are layered and then baked at a temperature equal to or higher than a dissolution temperature of the adhesive 16, whereby the multilayer ceramic condenser 12 is produced, as shown in FIG. 8(f).

In this method, the adhesive tape 15 having adhesive power in the approximate range of 50-500N/m is preferably used for the secondary transfer.

The metal transfer film of the present invention can be preferably used for the forming of electrodes of electronic components of other multilayer electronic components, as well as the forming of wiring and terminals of the circuit board, such as a printed board and equivalent, without limiting to the forming of multilayer ceramic condenser 12 mentioned above.

### EXAMPLES

While in the following, the present invention will be described in further detail with reference to Examples and Comparative Examples.

### Example 1

A carrier film comprising a polyethylene terephthalate film having thickness of 25 μm was prepared, first (See FIG. 2(a)), and, then, a copper thin layer having thickness of 800 Å was formed on the carrier film by the sputtering (See FIG. 2(b)). Then, this was dipped in electrolytic nickel plating solution and then voltage was applied thereto at a current density of 0.5 A/dm² for ten seconds in such a way that the copper thin layer side is cathode, for the electrolytic nickel plating. As a result of this, a nickel plated layer having thickness of 0.1 μm was formed on the copper thin layer (See FIG. 2(c)).

Thereafter, a plating resist comprising a photoresist was adhesive bonded to the nickel plated layer and was patterned in a photolithography process, to form an inverted pattern from a specific circuit pattern, as shown in FIG. 2(d).

Sequentially, this was dipped in the electrolytic nickel plating solution and then voltage was applied thereto for ten seconds in such a way that the nickel plated layer side is anode, to form a passive film on a surface of the nickel plated layer on which no plating resist was formed (See FIG. 2(e)). Sequentially, with the polarity reversed, voltage was applied thereto at the current density of 0.5 A/dm² for about sixty seconds in such a way that the passive film side is cathode, for the electrolytic nickel plating. After this manner, a nickel plated layer having thickness of 0.5 μm was formed on the surface of the passive film (See FIG. 2(f). Thereafter, the plating resist was removed by the chemical etching (See FIG. 2(g)), to obtain the metal transfer sheet.

### Example 2

A carrier film comprising a polyethylene terephthalate film having thickness of 25 μm was prepared, first (See FIG. 3(a)), and, then, a copper thin layer having thickness of 800 Å was formed on the carrier film by the sputtering (See FIG. 3(b)). Then, this was dipped in electrolytic nickel plating solution and then voltage was applied thereto at a current density of 0.5 A/dm² for ten seconds in such a way that the copper thin layer side is cathode, for the electrolytic nickel plating. As a result of this, a nickel plated layer having thickness of 0.1 μm was formed on the copper thin layer (See FIG. 3(c)).

Thereafter, a plating resist comprising a photoresist was adhesive bonded to the nickel plated layer and was patterned in a photolithography process, to form an inverted pattern from a specific circuit pattern (See FIG. 3(d)).

Sequentially, this was dipped in the electrolytic nickel plating solution and then voltage was applied thereto for ten seconds in such a way that the nickel plated layer side is anode, to form a passive film on a surface of the nickel plated layer on which no plating resist was formed (See FIG. 3(e)). Sequentially, with the polarity reversed, voltage was applied thereto at the current density of 0.5 A/dm² for ten seconds in such a way that the passive film side is cathode, for the electrolytic nickel plating. After this manner, a nickel plated layer having thickness of 0.1 μm was formed on the surface of the passive film (See FIG. 3(f)). Sequentially, this was dipped in the electrolytic copper plating solution and then voltage was applied thereto at the current density of 0.5 A/dm² for ten seconds in such a way that the nickel plated layer side is cathode and further was applied thereto at the current density of 2 A/dm² for thirty seconds, for the electrolytic copper plating. As a result of this, a copper plated layer having thickness of 0.5 μm was formed on the nickel plated layer (See FIG. 3(g)). Thereafter, the plating resist was removed by the chemical etching (See FIG. 3(h)), to obtain the metal transfer sheet.

### Example 3

A carrier film comprising a polyethylene terephthalate film having thickness of 25 μm was prepared, first (See FIG. 4(a)), and, then, a nickel thin film having thickness of 800 Å was formed on the carrier film by the sputtering (See FIG. 4(b)). Then, a plating resist comprising a photoresist was adhesive bonded to the nickel thin film and was patterned in a photolithography process, to form an inverted pattern from a specific circuit pattern (See FIG. 4(c)).

Thereafter, this was dipped in the electrolytic nickel plating solution and then voltage was applied thereto for ten seconds in such a way that the nickel thin film side is anode, to form a passive film on the surface of the nickel thin film on which no plating resist was formed (See FIG. 4(d)). Sequentially, with the polarity reversed, voltage was applied thereto at the current density of 0.5 A/dm² for about sixty seconds in such a way that the passive film side is cathode, for the electrolytic nickel plating. After this manner, a nickel plated layer having thickness of 0.5 μm was formed on the surface of the passive film (See FIG. 4(e)). Thereafter, the plating resist was removed by the chemical etching (See FIG. 4(f)), to obtain the metal transfer sheet.

### Example 4

A carrier film comprising a polyethylene terephthalate film having thickness of 25 μm was prepared, first (See FIG. 4(a)), and, then, a nickel thin film having thickness of 800 Å was formed on the carrier film by the sputtering (See FIG. 4(b)). Then, a plating resist comprising a photoresist was adhesive bonded to the nickel thin film and was patterned in a photolithography process, to form an inverted pattern from a specific circuit pattern (See FIG. 4(c)).

Thereafter, this was dipped in the electrolytic nickel plating solution and then voltage was applied thereto for ten seconds in such a way that the nickel thin film side is anode, to form a passive film on the surface of the nickel thin film on which no plating resist was formed (See FIG. 4(d)).

Sequentially, that was pulled out from the electrolytic nickel plating solution and dried for a while. Thereafter, that was dipped again in the electrolytic nickel plating solution and then voltage was applied thereto at the current density of 0.5 A/dm² for about sixty seconds in such a way that the passive film side is cathode, for the electrolytic nickel plating. After this manner, a nickel plated layer having thickness of 0.5 μm was formed on the surface of the passive film (See FIG. 4(e)). Thereafter, the plating resist was removed by the chemical etching (See FIG. 4(f)), to obtain the metal transfer sheet.

### Example 5

A carrier film comprising a polyethylene terephthalate film having thickness of 25 μm was prepared, first (See FIG. 4(a)), and, then, a nickel thin film having thickness of 800 Å was formed on the carrier film by the sputtering (See FIG. 4(b)). Then, a plating resist comprising a photoresist was adhesive bonded to the nickel thin film and was patterned in a photolithography process, to form an inverted pattern from a specific circuit pattern (See FIG. 4(c)).

Thereafter, this was dipped in the electrolytic nickel plating solution and then voltage was applied thereto for ten seconds in such a way that the nickel thin film side is anode, to form a passive film on the surface of the nickel thin film on which no plating resist was formed (See FIG. 4(d)).

Sequentially, that was pulled out from the electrolytic nickel plating solution and dried for a while. Thereafter, that was dipped in electrolytic copper plating solution and then voltage was applied thereto at the current density of 0.5 A/dm² for about thirty seconds in such a way that the passive film side is cathode and further applied thereto at the current density of 2 A/dm² for about ten minutes, for the electrolytic copper plating. After this manner, a copper plated layer having thickness of 10 μm was formed on the surface of the passive film (See FIG. 4(e)). Thereafter, the plating resist was removed by the chemical etching (See FIG. 4(f)), to obtain the metal transfer sheet.

### Example 6

A carrier film comprising a polyethylene terephthalate film having thickness of 25 μm was prepared, first (See FIG. 5(a)), and, then, a copper thin film having thickness of 800 Å was formed on the carrier film by the sputtering (See FIG. 5(b)). Then, this was dipped in electrolytic nickel plating solution and then voltage was applied thereto at a current density of 0.5 A/dm² for ten seconds in such a way that the copper thin film side is cathode, for the electrolytic nickel plating. As a result of this, a nickel plated layer having thickness of 0.1 μm was formed on the copper thin film (See FIG. 5(c)).

Sequentially, with the polarity reversed in the electrolytic nickel plating solution, voltage was applied thereto for ten seconds in such a way that the nickel plated layer side is anode, to form a passive film on the surface of the nickel plated layer (See FIG. 5(d)). Sequentially, with the polarity reversed, voltage was applied thereto at the current density of 0.5 A/dm² for about sixty seconds in such a way that the passive film side is cathode, for the electrolytic nickel plating. After this manner, a nickel plated layer having thickness of 0.5 μm was formed on the surface of the passive film (See FIG. 5(e)).

Thereafter, an etching resist comprising a photoresist was adhesive bonded to the nickel plated layer and was patterned in a photolithography process, to form an identical pattern to a specific circuit pattern (See FIG. 5(f)).

Then, with the etching resist as the resist, an upper nickel plated layer, the passive film, and a lower nickel plated layer were chemically etched (See FIG. 5(g)). Thereafter, the etching resist was removed by the chemical etching (See FIG. 5(h)), to obtain the metal transfer sheet.

### Comparative Example 1

A carrier film comprising a polyethylene terephthalate film having thickness of 25 μm was prepared, first, and, then, a copper thin film having thickness of 800A was formed on the carrier film by the sputtering. Then, this was dipped in electrolytic nickel plating solution and then voltage was applied thereto at a current density of 0.5 A/dm² for ten seconds in such a way that the copper thin film side is cathode, for the electrolytic nickel plating. As a result of this, a nickel plated layer having thickness of 0.1 μm was formed on the copper thin film.

Thereafter, a plating resist comprising a photoresist was adhesive bonded to the nickel plated layer and was patterned in a photolithography process, to form an inverted pattern from a specific circuit pattern.

Sequentially, this was dipped in the electrolytic nickel plating solution and then voltage was applied thereto at the current density of 0.5 A/dm² for about sixty seconds in such a way that the nickel plated layer side is cathode, for electrolytic nickel plating, to form a nickel plated layer having thickness of 0.5 μm on the surface of the nickel plated layer, without forming any passive film therebetween. Thereafter, the plating resist was removed by the chemical etching, to obtain the metal transfer sheet.

### Comparative Example 2

A carrier film comprising a polyethylene terephthalate film having thickness of 25 μm was prepared, first, and, then, a copper thin film having thickness of 800 Å was formed on the carrier film by the sputtering. Then, this was dipped in electrolytic nickel plating solution and then voltage was applied thereto at a current density of 0.5 A/dm² for ten seconds in such a way that the copper thin film side is cathode, for the electrolytic nickel plating. As a result of this, a nickel plated layer having thickness of 0.1 μm was formed on the copper thin film.

Sequentially, a nickel thin film having thickness of 1,000 Å was formed on a surface of this nickel plated layer by the sputtering. Thereafter, this was dipped in electrolytic nickel plating solution and then voltage was applied thereto at a current density of 0.5 A/dm² for about sixty seconds in such a way that the nickel thin film side is cathode, for the electrolytic nickel plating. As a result of this, a nickel plated layer having thickness of 0.5 μm was formed on the nickel thin film.

Thereafter, an etching resist comprising a photoresist was adhesive bonded to this nickel plated layer and was patterned in a photolithography process, to form an identical pattern to a specific circuit pattern. Sequentially, with this etching resist as the resist, an upper nickel plated layer, the nickel thin film, and a lower nickel plated layer were chemically etched. Thereafter, the etching resist was removed by the chemical etching, to obtain the metal transfer sheet.

Evaluation

The metal transfer sheets of Examples and Comparative Examples produced were each put to the peel test ten times in such a way that the adhesive tape having adhesion strength of 100N/m is bonded to the upper plated layer of the metal transfer sheet formed in a circuit pattern and then is peeled off, to examine the probability that its plated layer may be transferred to the adhesive tape. The results are shown in TABLE 1 given below.

TABLE 1

| Examples/Comparative Examples | Probability of Transfer (%) |
|---|---|
| Example 1 | 100 |
| Example 2 | 100 |
| Example 3 | 100 |
| Example 4 | 100 |
| Example 5 | 100 |
| Example 6 | 100 |
| Comparative Example 1 | 0 |
| Comparative Example 2 | 0 |

While the illustrative embodiments of the present invention are provided in the above description, such is for illustrative purpose only and it is not to be construed restrictively. Modification and variation of the present invention that will be obvious to those skilled in the art is to be covered by the following claims.

What is claimed is:

1. A metal transfer sheet, wherein a first metal layer and a second metal layer are laminated through a passive film interposed therebetween.

2. The metal transfer sheet according to claim 1, wherein the first metal layer is formed of nickel.

3. The metal transfer sheet according to claim 1, wherein the second metal layer is formed of nickel.

4. The metal transfer sheet according to claim 1, wherein the second metal layer is formed of copper.

5. The metal transfer sheet according to claim 1, wherein the second metal layer comprises a plurality of metal layers.

6. The metal transfer sheet according to claim 5, wherein the second metal layer comprises a nickel layer and a copper layer.

7. The metal transfer sheet according to claim 1, wherein the first metal layer is formed in a vapor deposition method or an electrolytic plating method.

8. The metal transfer sheet according to claim 7, wherein the second metal layer is formed in the electrolytic plating method.

9. The metal transfer sheet according to claim 8, wherein the passive film is formed in such a way that voltage is applied in plating solution with its polarity reversed with respect to the electrolytic plating of the second metal layer.

10. A metal transfer sheet producing method, comprising the steps:
of preparing a first metal layer;
of forming a passive film by applying voltage in plating solution in such a way that the first metal layer side is anode; and
of forming a second metal layer by applying voltage in the plating solution in such a way that the passive film side is cathode.

11. The metal transfer sheet producing method according to claim 10, wherein the voltage is applied for 2-10 seconds in the step of forming the passive film.

12. A method of producing a ceramic condenser using a metal transfer sheet having a first metal layer and a second metal layer which are laminated through a passive film interposed therebetween, the method comprising the steps:
of transferring the second metal layer of the metal transfer sheet to a ceramic green sheet;
of laminating the ceramic green sheet to which the second metal layer was transferred; and
of baking the ceramic green sheet laminated.
